(19) United States
(12) Patent Application Publication
(10) Pub. No.: US 2023/0398670 A1
(43) Pub. Date: Dec. 14, 2023

(54) LIFTING GEAR ASSEMBLY AND ELECTRIC NAIL GUN HAVING THE SAME

(71) Applicant: BASSO INDUSTRY CORP., Taichung (TW)

(72) Inventors: An-Gi LIU, Taichung (TW); Chang-Sheng Lin, Taichung (TW); Fu-Ying Huang, Taichung (TW)

(73) Assignee: BASSO INDUSTRY CORP., Taichung (TW)

(21) Appl. No.: 18/331,322

(22) Filed: Jun. 8, 2023

(30) Foreign Application Priority Data
Jun. 9, 2022 (TW) 111121456

(51) Int. Cl. B25C 1/04; B25C 1/06

(52) U.S. Cl. CPC B25C 1/047; B25C 1/06; B25C 1/041

(57) ABSTRACT

A lifting gear assembly for an electric nail gun that strikes a nail in a nail-striking direction includes a muzzle seat connected to the electric nail gun, a sprocket unit including two sprocket wheels spaced apart from each other and rotatably mounted in the electric nail gun, a motor unit for driving rotation of one of the sprocket wheels, and a chain unit including a roller chain trained on the sprocket wheels and a lifting gear device mounted to the roller chain. The lifting gear device includes a pushing member driven movably by the roller chain along a path having a stroke in which the pushing member moves in a pressure-generating direction opposite to the nail-striking direction. The pushing member pushes the striking pin, when moving along the first stroke, to move the striking pin from a post-striking position to a pre-striking position.

### CROSS-REFERENCE TO RELATED APPLICATION

This application claims priority to Taiwanese Invention Patent Application No. 111121456, filed on Jun. 9, 2022.

### FIELD

The disclosure relates to a lifting gear assembly, and more particularly to an electric nail gun having the same.

### BACKGROUND

U.S. Pat. No. 8,011,547B2 discloses a driving tool including a lifting gear that drives a striking pin to strike a nail. The striking pin is processed to include a plurality of teeth engaging the lifting gear so as to be driven thereby to strike the pin. Such design is relatively complex and is troublesome to manufacture.

Referring to FIG. 1, a driving device 9 disclosed in Chinese Patent Publication No. 212020643U includes an energy storage unit 91, a striking unit 92 connected to the energy storage unit 91, a driving unit 93 for moving the striking unit 92 to compress air in the energy storage unit 91 to store energy, and a release mechanism 94. The striking unit 92 includes a piston (not shown) that is disposed in the energy storage unit 91, and a striking pin 921 that is connected fixedly to the piston, that is opposite to the energy storage unit 91, and that has a protruding tooth 922. The driving unit 93 includes a gear rack 931, a gear 932, and a locking mechanism 933. The gear rack 931 is disposed parallel to one lateral side of the striking unit 92. The gear 932 is disposed between the gear rack 931 and the striking pin 921, engages the gear rack 931, and is driven by electric power to move the gear rack 931 toward the energy storage unit 91. The locking mechanism 933 is connected co-movably to the gear rack 931, is mounted pivotably on the gear rack 931, and is operable to abut against the protruding tooth 922 of the striking pin 921 so as to push the striking pin 921 toward the energy storage unit 91 while being moved toward the energy storage unit 91. The release mechanism 94 is disposed adjacent to the energy storage unit 91 and has an inclined surface 941 facing the gear rack 931.

The gear rack 931 is driven by the gear 932, which is rotated by electric power, to move toward the energy storage unit 91 so that the locking mechanism 933 abuts against the protruding tooth 922 to move the striking pin 921 toward the energy storage unit 91, and the piston compresses air in the energy storage unit 91 to store energy until the locking mechanism 933 is in contact with and guided by the inclined surface 941 of the release mechanism 94. At this position, the locking mechanism 933 is no longer abutting against the protruding tooth 922 and pivots relative to the gear rack 931, so that the striking pin 921 is moved by the energy stored in the energy storage unit 91 in a direction away from the energy storage unit 91 to strike a nail to thereby complete a nail-striking operation.

Although the striking pin 921 of the driving device 9 includes only one protruding tooth 922 and is easier to manufacture than the striking pin disclosed in U.S. Pat. No. 8,011,547B2, it is necessary to include the driving unit 93 and the release mechanism 94 in the driving device 9 which are also relative complex and may increase manufacture cost.

### SUMMARY

Therefore, an object of the disclosure is to provide a lifting gear assembly and an electric nail gun having the lifting gear assembly that has a configuration which is different from the abovementioned prior art.

According to an aspect of the disclosure, a lifting gear assembly is adapted for use in an electric nail gun. The electric nail gun includes a trigger device that is operable to start a striking cycle, a cylinder unit that stores air therein and that is isolated from an external environment during the striking cycle, and a striking unit that includes a striking pin movable in a nail-striking direction by air pressure in the cylinder unit from a pre-striking position to a post-striking position to strike a nail. The striking pin has a driven protrusion. The lifting gear assembly includes a muzzle seat, a sprocket unit, a motor unit, and a chain unit. The muzzle seat is adapted to be connected to the cylinder unit, and has an accommodating space and a nail-striking passage that is in spatial communication with the accommodating space and that extends in the nail-striking direction. The sprocket unit includes two sprocket wheels that are spaced apart from each other in the nail-striking direction and that are rotatably mounted in the accommodating space. The motor unit is mounted to the muzzle seat and is operable for driving rotation of one of the sprocket wheels. The chain unit includes a roller chain and at least one lifting gear device. The roller chain is trained on the sprocket wheels. The at least one lifting gear device is mounted to the roller chain, and includes a pushing member driven movably by the roller chain along a path. The path has a first stroke in which the pushing member moves in a pressure-generating direction opposite to the nail-striking direction. The pushing member is adapted to push the driven protrusion of the striking pin, when moving along the first stroke, to move the striking pin from the post-striking position to the pre-striking position to thereby increase air pressure in the cylinder.

According to another aspect of the disclosure, an electric nail gun includes a main body unit, a cylinder unit, a striking unit, and the abovementioned lifting gear assembly. The main body unit includes a trigger device operable to start a striking cycle. The cylinder unit is mounted to the main body unit, and has an air storage chamber and a cylinder chamber. The air storage chamber stores air therein and is isolated from an external environment during the striking cycle. The cylinder chamber is in spatial communication with the air storage chamber. The striking unit is inserted in the cylinder chamber and includes a striking pin that is movable in a nail-striking direction by air pressure in the cylinder unit from a pre-striking position to a post-striking position to strike a nail. The striking pin has a driven protrusion.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of a driving machine disclosed in Chinese Patent Publication No. 212020643U.

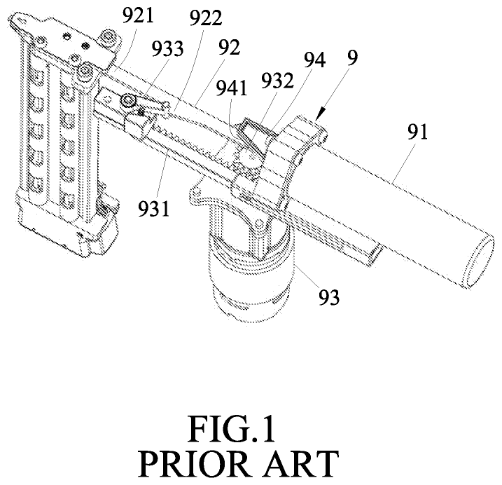

FIG. 2 is a perspective view of an electric nail gun of an embodiment according to the present disclosure.

FIG. 3 is a fragmentary perspective view of the embodiment, illustrating a cylinder unit, a muzzle seat, and a blocking unit of the embodiment.

FIG. 4 is a fragmentary sectional view of the embodiment, illustrating a striking pin of the embodiment being at a standby position.

FIG. 5 is a fragmentary partly exploded perspective view, illustrating the striking pin, a sprocket unit, a chain unit, and the blocking unit of the embodiment.

FIG. 6 is a view similar to FIG. 4, but illustrating that the striking pin is disposed at a pre-striking position.

FIG. 7 is a fragmentary sectional view taken along line VII-VII in FIG. 6.

FIG. 8 is a fragmentary sectional view similar to FIG. 4, but illustrating that the striking pin is moved from the pre-striking position to a post-striking position.

FIG. 9 is a fragmentary sectional view similar to FIG. 4, but illustrating that the striking pin is disposed at the post-striking position.

FIG. 10 is a fragmentary sectional view similar to FIG. 4, but illustrating a pushing member of the embodiment abutting against a driven protrusion of the striking pin.

FIG. 11 is a fragmentary sectional view taken along line XI-XI of FIG. 10.

FIG. 12 is a fragmentary sectional view similar to FIG. 4, but illustrating that the striking pin is moved from the post-striking position toward the standby position.

FIG. 13 is a fragmentary sectional view taken along line XIII-XIII of FIG. 12.

FIG. 14 is a fragmentary sectional view similar to FIG. 13, but illustrating that a blocking member of the embodiment engaging a selected one of limiting protrusions of the striking pin.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

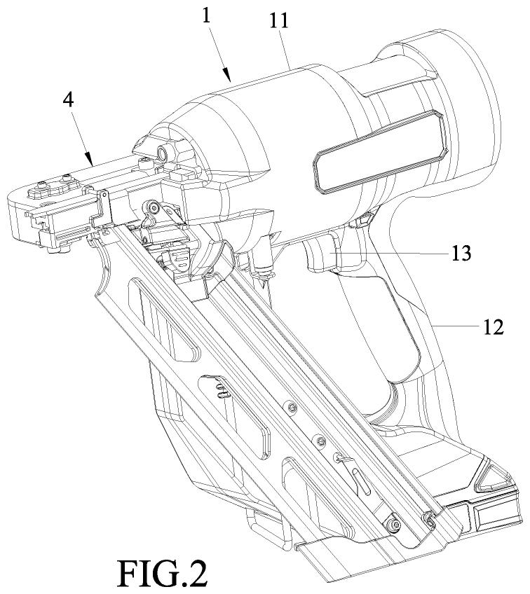

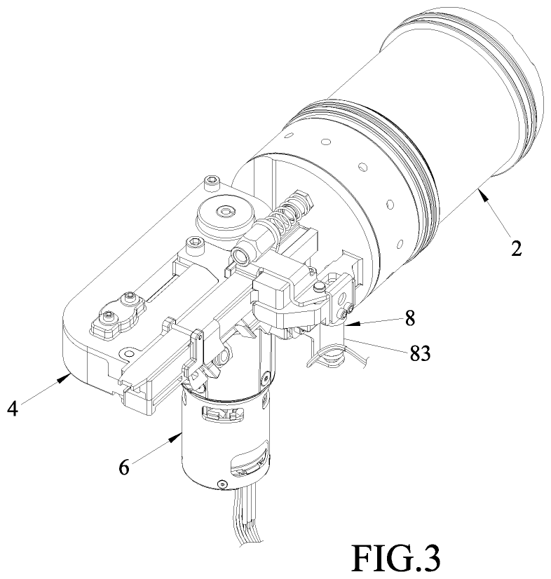

Referring to FIGS. 2 to 4, an electric nail gun of an embodiment according to the present disclosure includes a main body unit 1, a cylinder unit 2, a nail-striking unit 3, a lifting gear assembly, and a blocking unit 8. The lifting gear assembly includes a muzzle seat 4, a sprocket unit 5, a motor unit 6, and a chain unit 7.

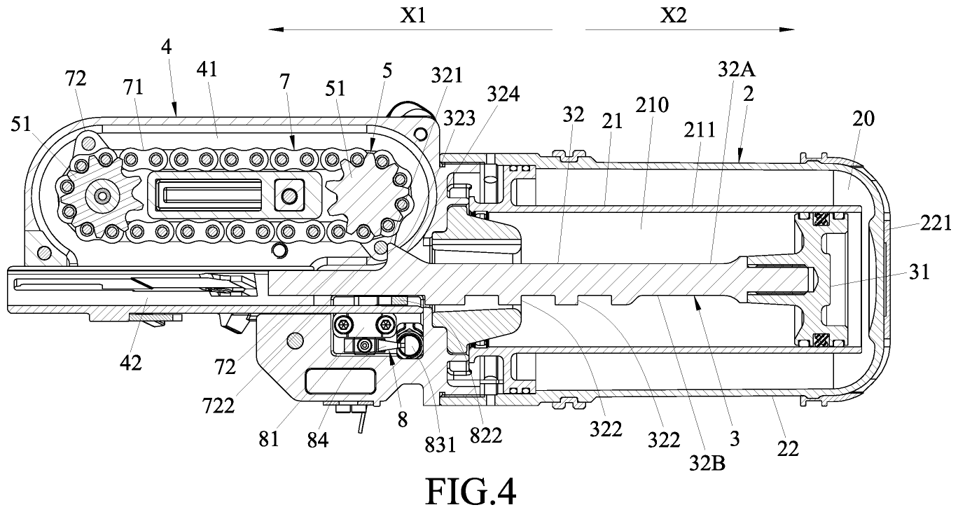

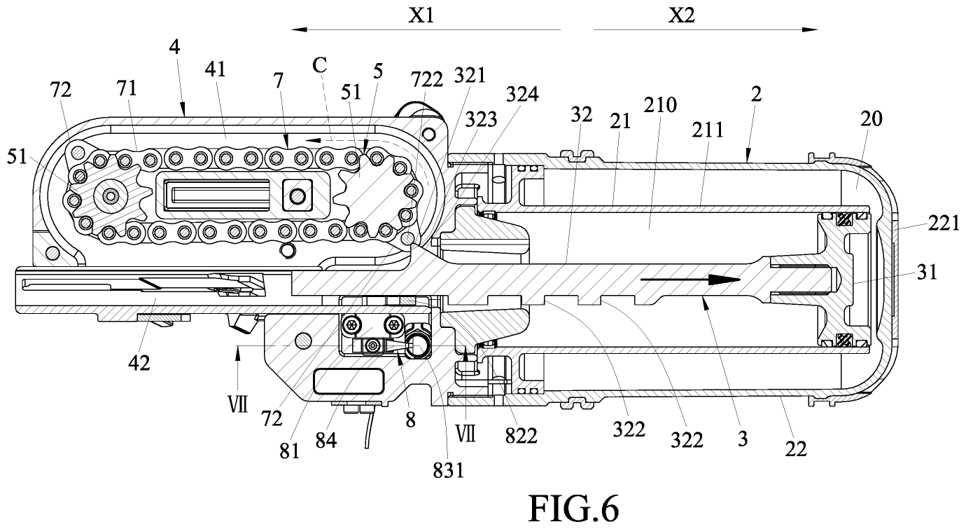

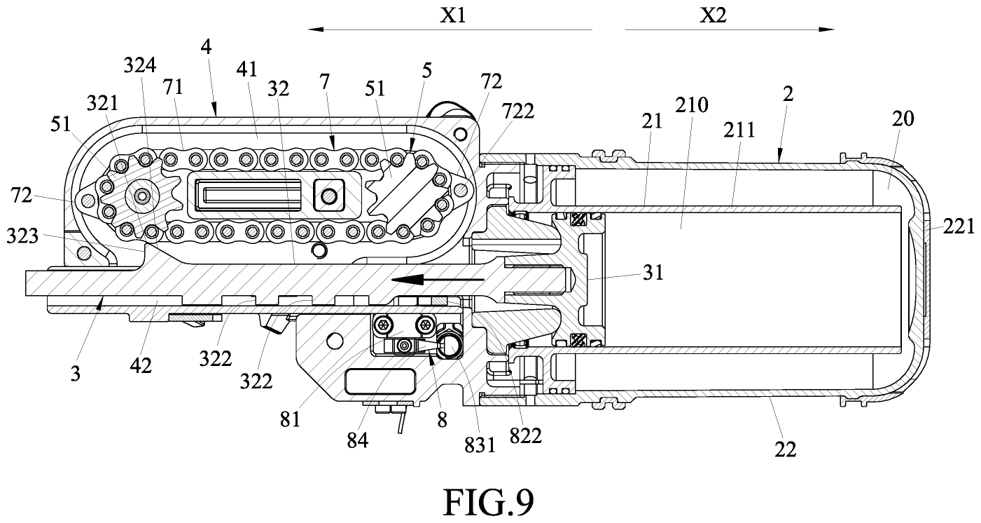

The main body unit 1 includes a main body 11, a handle 12 connected to the main body 11 and accessible by a user, and a trigger device 13 mounted to the handle 12 and operable to start a striking cycle. The striking cycle refers to a period from the time that the striking unit 3 starts to move from a standby position (see FIG. 4) to a pre-striking position (see FIG. 6) and then moves from the pre-striking position to a post-striking position (see FIG. 9) to strikes a nail until the time that the striking unit 3 moves back to the standby position.

The cylinder unit 2 is mounted in the main body 11 of the main body unit 1, and includes a striking cylinder 21 and an air storage cylinder 22. The striking cylinder 21 is disposed in the air storage cylinder 22, and includes a cylinder body 211 that defines a cylinder chamber 210 therein. The air storage cylinder 22 cooperates with the striking cylinder 21 to define an air storage chamber 20 therebetween. The air storage chamber 20 stores air therein, is in spatial communication with the cylinder chamber 210, and is isolated from the external environment during the striking cycle. In this embodiment, the air storage chamber 20 stores air having an air pressure that is equal to or greater than a predetermined threshold. The air storage cylinder 22 includes an end portion 221 that is spaced apart from the striking cylinder 21 in a nail-striking direction (X1). In fact, only when the air pressure in the air storage chamber 20 drops below the predetermined threshold, will the air storage chamber 20 that is connected to an external air source (not shown) begin to supply air to the air storage chamber 20 until the air pressure therein is equal to or greater than the predetermined threshold.

The nail-striking unit 3 is inserted in the cylinder chamber 210 and is for striking a nail (not shown). The nail-striking unit 3 includes a piston 31 in airtight contact with an inner surface of the cylinder body 211, and a striking pin 32 connected to the piston 31 and movable in the nail-striking direction (X1) by air pressure in the air storage chamber 20 from the pre-striking position to the post-striking position to strike the nail. The striking pin 32 has two longitudinal side surfaces 32A, 32B, a driven protrusion 321, and a plurality of limiting protrusion 322. The longitudinal side surfaces 32A, 32B extend in the nail-striking direction (X1) and are opposite in a direction transverse to the nail-striking direction (X1). The driven protrusion 321 protrudes from one of the longitudinal side surfaces 32A, and has an abutment surface 323 that is substantially perpendicular to the nail striking direction (X1) and an inclined surface 324 that interconnects a distal end of the abutment surface 323 and the longitudinal side surface 32A. The limiting protrusions 322 protrudes from the other one of the longitudinal side surfaces 32B, are spaced apart from each other in the nail-striking direction (X1), and are opposite to the driven protrusion 321 in a direction transverse to the nail-striking direction (X1). In this embodiment, the abutment surface 323 is perpendicular to the longitudinal side surface 32A and a distance between the inclined surface 324 and the longitudinal side surface 32A decreases in the pressure-generating direction (X2). By virtue of design of the inclined surface 324, a distance between the chain unit 7 and the driven protrusion 321 is sufficient to ensure smooth movement of the striking pin 32 in both of the nail-striking direction (X1) and the pressure-generating direction (X2) so that movement of the striking pin 32 is not obstructed by the chain unit 7.

The striking pin 32 (and the piston 31) is movable among the standby position (see FIG. 4), the pre-striking position (see FIG. 6), and the post-striking position (see FIG. 9). When the striking pin 32 is at the standby position, the piston 31 is disposed adjacent to and spaced apart from the end portion 221 in the pressure-generating direction (X2). When the striking pin 32 moves from the standby position to the pre-striking position, air pressure in the air storage chamber 20 is increased and the striking pin 32 is moved to a top dead center of the air storage cylinder 22. At this position, the piston 31 is disposed closer to the end portion 221 than the striking pin 32 is at the standby position and is spaced apart from the end portion 221 by a minimum distance in the nail-striking direction (X1). When the striking pin 32 moves from the pre-striking position to the post-striking position, the striking pin 32 is driven by air pressure in the air storage chamber 20 to strike the nail. The striking pin 32 is disposed at a bottom dead center of the air storage cylinder 22 when being at the post-striking position, and the piston 31 is disposed farther from the end portion 221 than the striking pin 32 is at the standby position and the pre-striking position. That is to say, the piston 31 is spaced apart from the end portion 221 by a maximum distance in the nail-striking direction (X1).

Referring back to FIGS. 2, 4 and 5, the muzzle seat 4 is connected to the cylinder unit 2 and the main body 11, and is adapted to guide the nail (not shown) to move therealong. Specifically, the muzzle seat 4 has an accommodating space 41 and a nail-striking passage 42. The nail-striking passage 42 receives the striking pin 32 therein, is in spatial communication with the accommodating space 41, and extends in the nail-striking direction (X1). The nail-striking passage 42 permits and guides the striking pin 32 to strike the nail moving therealong.

The sprocket unit 5 includes two sprocket wheels 51 spaced apart from each other in the nail-striking direction (X1) and disposed in the accommodating space 41. Each of the sprocket wheels 51 is rotatably mounted in the accommodating space 41.

The motor unit 6 is mounted to the muzzle seat 4, and is operable to drive rotation of one of the sprocket wheels 51. In this embodiment, when the trigger device 13 is operated to start the striking cycle, the motor unit 6 is enabled to thereby drive rotation of the one of the sprocket wheels 51.

The chain unit 7 includes a roller chain 71 trained on the sprocket wheels 51, and two lifting gear devices 72 mounted to the roller chain 71 and spaced apart from each other. In some variations, the number of the lifting modules 72 may be only one or more than two, and the present disclosure is not limited to the number of the lifting modules 72.

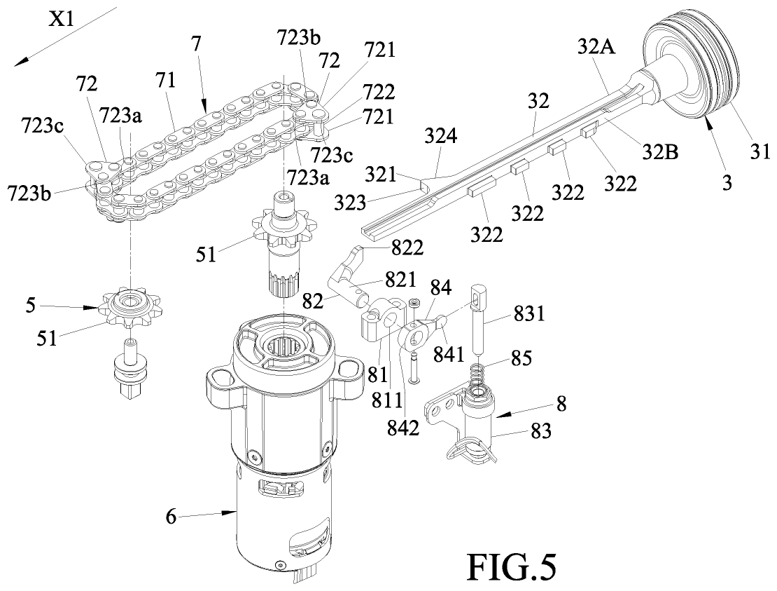

Since the structure of each of the lifting gear devices 72 is identical, only one of the lifting gear devices 72 will be described in the following description for the sake of brevity. As shown in FIG. 5, the lifting gear device 72 includes two positioning plates 721 and a pushing member 722. Each of the positioning plates 721 has a first vertex portion 723a, a second vertex portion 723b, and a third vertex portion 723c. For each of the positioning plates 721, the first vertex portion 723a and second the vortex portion 723b are connected fixedly to the roller chain 71, and third vertex portion 723c protrudes outwardly from the roller chain 71. The pushing member 722 is connected rotatably between the third vertex portions 723c of the positioning plates 721. The pushing member 722 is driven by the roller chain 71 to move along a path. The path is closed, and has a first stroke, in which the pushing member 722 moves in the pressure-generating direction (X2), and a second stroke, in which the pushing member 722 moves in the nail-striking direction (X1). In this embodiment, the first stroke and the second stroke are parallel to each other, are spaced apart along a direction transverse to the nail-striking direction (X1), and are both straight. The pushing member 722 pushes the driven protrusion 321, when moving along the first stroke, to move the striking pin 32 from the post-striking position to the pre-striking position to thereby increase air pressure in the air storage chamber 20 of the cylinder 2. Specifically, the pushing member 722 abuts against the abutment surface 323 of the driven protrusion 321 of the striking pin 32, when moving along the first stroke, to move the striking pin 32 from the post-striking position to the pre-striking position in the pressure-generating direction (X2). On the other hand, the pushing member 722 is away from the driven protrusion 321 when moving along the second stroke.

The blocking unit 8 includes a positioning seat 81, a blocking member 82, a driving set 83, a rotary arm 84, and a biasing member 85.

Referring to FIGS. 4, 5 and 7, the positioning seat 81 is connected to the muzzle seat 4, and is formed with a through hole 811 extending in a direction perpendicular to the nail-striking direction (X1).

The blocking member 82 extends rotatably through the through hole 811. Specifically, the blocking member 82 includes a rotating portion 821 that extends rotatably through the positioning seat 81 and a pawl portion 822 that is connected to the rotating portion 821, that is disposed between the positioning seat 81 and the striking pin 32, and that is adjacent to one of the limiting protrusions 322 when the striking pin 32 is at the pre-striking position to obstruct movement of the striking pin 32 toward the post-striking position. The pawl portion 822 has an upright surface that is transverse to the nail-striking direction (X1) and that faces the piston 31, and a cammed surface that is opposite to the piston 31 and the upright surface and that is operable to contact the limiting protrusions 322.

The rotary arm 84 is disposed adjacent to one side of the positioning seat 81 that is opposite to the pawl portion 822 of the blocking member 82, and has a first end 841 and a second end 842 opposite to the first end 841 and connected co-rotatably to the rotating portion 821. The rotating portion 821 of the blocking member 82 extends sequentially through the through hole 811 of the positioning seat 81 and the second end 842 of the rotary arm 84.

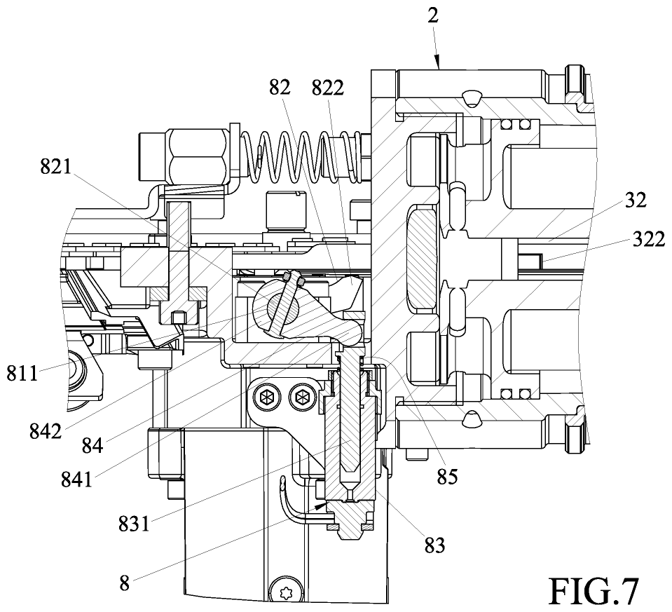

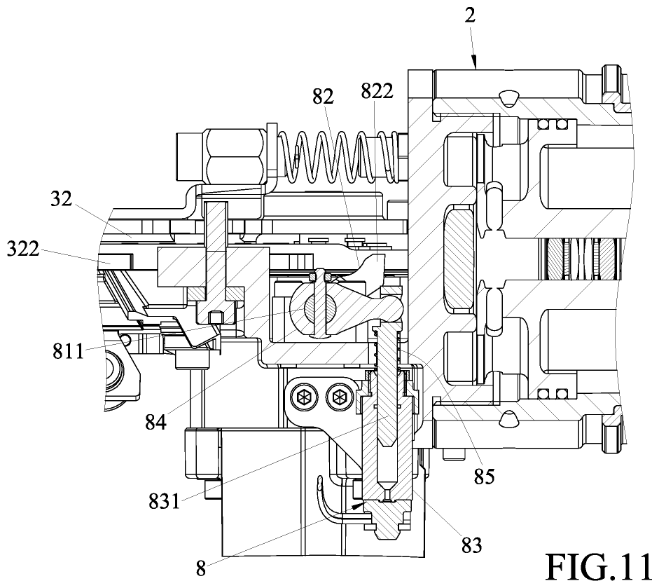

The driving set 83 is operable to move the blocking member 82 away from the one of the limiting protrusions 322 to allow movement of the striking pin 32 toward the post-striking position. Specifically, the driving set 83 is connected to the rotary arm 84 for driving the rotary arm 84 to rotate. In this embodiment, the driving set 83 includes a valve rod 831. The valve rod 831 is connected fixedly to the first end 841 of the rotary arm 84 and is movable between an extended position (see FIG. 11) and a retracted position (see FIG. 7) to drive rotation of the rotary arm 84, thereby resulting in rotation of the rotation portion 821. Rotation of the rotation portion 821 drives the pawl portion 822 to be adjacent to and away from the one of the limiting protrusions 322. As shown in FIG. 6, when the striking pin 32 is at the pre-striking position and the valve rod 831 is at the extended position, the pawl portion 822 is moved, via the rotary arm 84, to be adjacent to the one of the limiting protrusions 322. At this position, the pawl portion 822 is disposed downstream of the one of the limiting protrusions 322 and the upright surface of the pawl portion 822 faces and will abut against the one of the limiting protrusions 322 to obstruct movement of the striking pin 32 toward the post-striking position in the nail-striking direction (X1). On the other hand, as shown in FIG. 7, when the driving set 83 is energized, the valve rod 831 is moved thereby from the extended position (see FIG. 11) to the retracted position. When the striking pin 32 is at the pre-striking position and the valve rod 831 is at the retracted position, the pawl portion 822 is moved, via the rotary arm 84, away from the one of the limiting protrusions 322. In this embodiment, the driving set 83 is a solenoid valve and since the main feature of this disclosure does not reside in the solenoid valve, persons having ordinary skill in the pertinent art may make various modifications to the solenoid valve to serve as the driving set 83 and further details of the same are omitted herein for the sake of brevity.

The biasing member 85 is sleeved on the valve rod 831 and provides a biasing force for biasing the valve rod 831 toward the extended position. In this embodiment, the biasing member 85 is a compression spring.

Referring back to FIG. 4, when the striking pin 32 (and the piston 31) is disposed at the standby position, one of the pushing members 722 of the lifting gear devices 72 abuts against the abutment surface 323 of the driven protrusion 321. At this position, the valve rod 831 of the driving set 83 is at the extended position by virtue of the biasing force provided by the biasing member 85, such that the pawl portion 822 of the blocking member 82 is disposed downstream of the limiting protrusions 322 to obstruct the striking pin 32 from moving to the nail-striking position. In this way, an unintentional nail striking may be prevented.

Referring to FIGS. 2, 6, and 7, when the trigger device 13 is operated by a user to start the striking cycle, electric power provided by the motor unit 6 drives rotation of one of the sprocket wheels 51, and the roller chain 71 is driven thereby to circulate in a counter-clockwise direction depicted by a dashed arrow (C) in FIG. 6. At this position, the driving set 83 is energized to move the valve rod 831 toward the retracted position such that the pawl portion 822 of the blocking member 82 is rotated, via the first end 841 of the rotary arm 84, away from the striking pin 32 and the one of the limiting protrusions 322. In this way, during circulation of the roller chain 71 in the counter-clockwise direction, one of the pushing members 722 that moves along the first stroke abuts against the abutment surface 323 of the driven protrusion 321 to move the striking pin 32 in the pressure-generating direction (X2) toward the pre-striking position, i.e., the top dead center. It should be noted that, in this embodiment, the other one of the pushing members 722 moves along the second stroke while the one of the pushing members 722 moves along the first stroke.

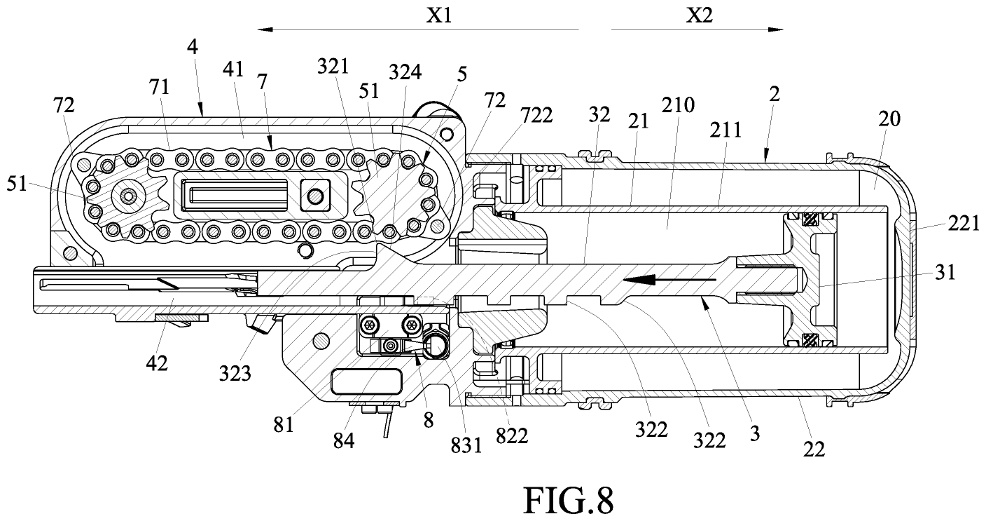

With reference to FIG. 8, as the roller chain 71 circulates in the counter-clockwise direction, the one of the pushing members 722 moving along the first stroke is not in contact with the driven protrusion 321 of the striking pin 32, and the other one of the pushing members 722 is also not in contact with the driven protrusion 321. At this position, the striking pin 32 is not blocked by either one the pushing members 722 or the blocking member 82. Thus, as shown in FIG. 9, the piston 31 is pushed by air pressure in the air storage chamber 20 to urge the striking pin 32 to move along the nail-striking passage 42 of the muzzle seat 4 in the nail-striking direction (X1) so as to strike the nail. In this way, the striking pin 32 is moved to the post-striking position to complete a nail-striking operation.

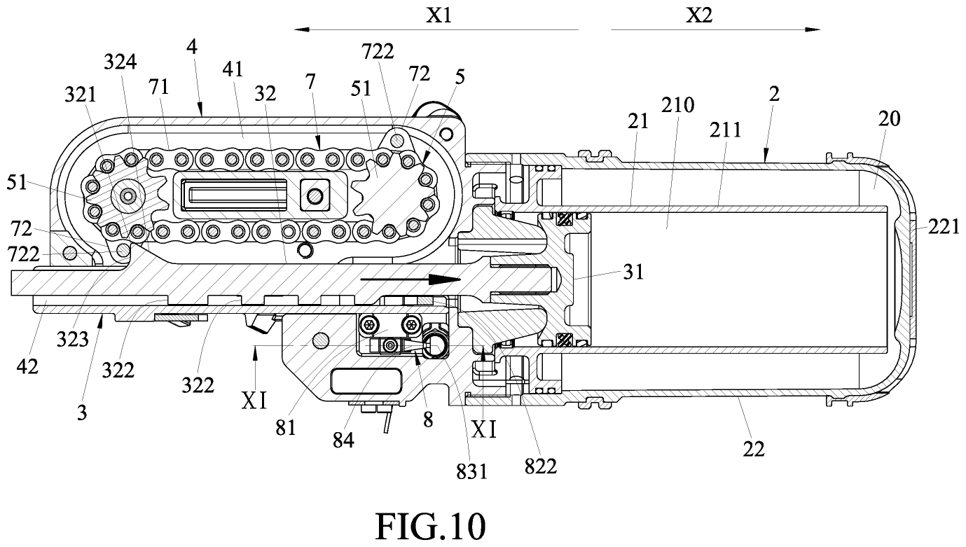

Further referring to FIGS. 10 and 11, after the nail-striking operation is completed, the striking pin 32 is at the post-striking position, and the driving set 83 is not energized so the valve rod 831 is biased by the biasing member 85 to the extended position and the pawl portion 822 of the blocking member 8 is moved, via the rotary arm 84, to be adjacent to one of the limiting protrusions 322, i.e., downstream of the one of the limiting protrusions 322. The motor unit 6 continues to drive rotation of one of the sprocket wheels 51 and thus circulation of the roller chain 71 in the counter-clockwise direction, so that the other one of the pushing members 722, which moves along the second stroke previously, moves along the first stroke and abuts against the abutment surface 323 of the limiting protrusion 322 to move the striking pin 32 (and the piston 31) to the standby position (see FIG. 4) again to complete the striking cycle. By repeating the abovementioned procedure, function of a pneumatic nail-striking operation using air pressure while generating air pressure with electric power may be achieved.

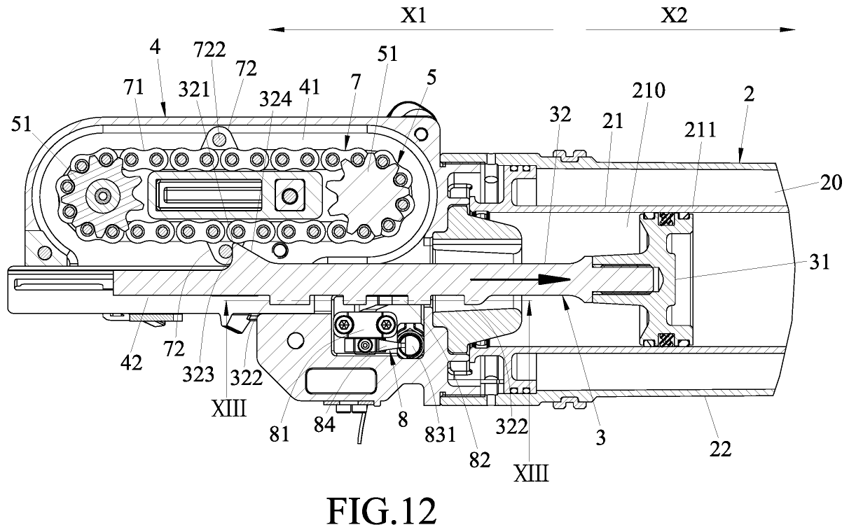

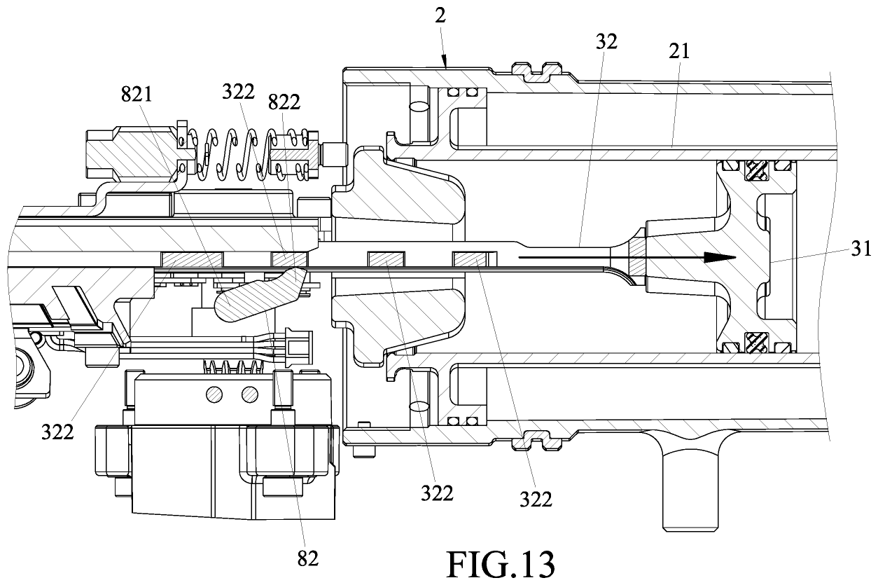

Further referring to FIGS. 11 to 13, it should be noted that, after one nail striking operation is completed and the striking pin 32 is moving from the post-striking position to the standby position, the valve rod 831 is biased by the biasing member 85 to the extended position. The limiting protrusions 322 sequentially pushes the cammed surface of the pawl portion 822 of the blocking member 82 to drive rotation of the rotating portion 821 of the blocking member 82, thereby resiliently moving the valve rod 831, via the rotary arm 84 to the retracted position against the biasing force of the biasing member 85 during movement of the striking pin 32 from the post-striking position to the standby position in the pressure-generating direction (X2).

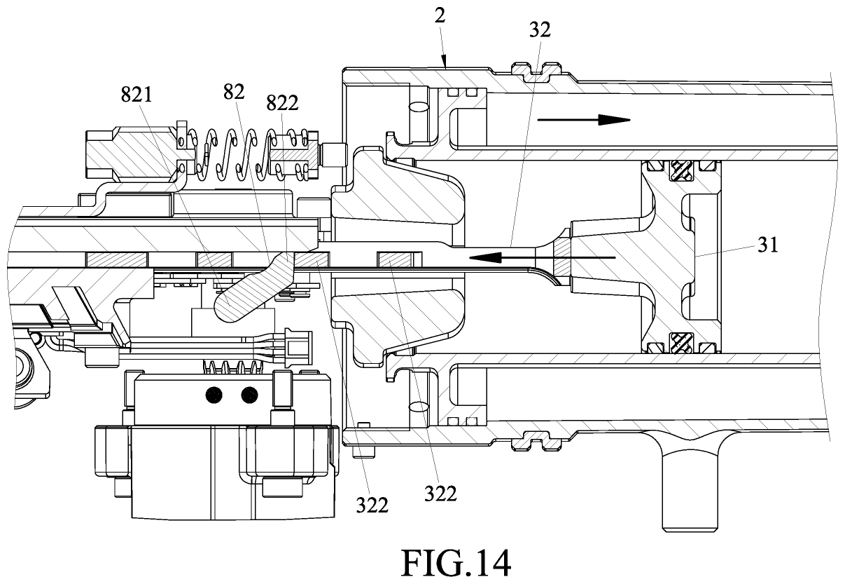

Referring to FIG. 14, when the striking pin 32 (and the piston 31) is disposed at the standby position and the valve rod 831 is at the extended position, the pawl portion 822 of the blocking member 82 is disposed adjacent to one of the limiting protrusions 322, i.e., downstream of the limiting protrusions 322 in the nail-striking direction (X1). By virtue of the blocking unit 8, in case where the striking pin 32 is unintentionally or accidentally moved in the nail-striking direction (X1), once one of the limiting protrusions 322 abuts against the upright surface of the pawl portion 822 of the blocking member 82, movement of the striking pin 32 in the nail-striking direction (X1) is arrested by the blocking member 82, so that the striking pin 32 may not be further moved in the nail-striking direction (X1). In this way, a protecting function may be achieved.

Through the above description, the advantages of the embodiment of the present disclosure may be summarized as follows:

The lifting gear assembly having a configuration different from a gear rack disclosed in Chinese Patent Publication No. 212020643U is provided. In the embodiment of the present disclosure, the chain unit 7 is driven by the sprocket unit 5 to drive movement of the striking pin 32 in the pressure-generating direction (X2). During circulation of the roller chain 71, the pushing member 722 of one of the lifting modules 72 that moves along the first stroke pushes the driven protrusion 321 of the striking pin 32 to move the striking pin 32 to the pre-striking position. Additionally, the blocking member 8 arrests the striking pin 32 from being unintentionally moved in the nail-striking direction (X1) to achieve the protecting function.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A lifting gear assembly adapted for use in an electric nail gun, the electric nail gun including a trigger device that is operable to start a striking cycle, a cylinder unit that stores air therein and that is isolated from an external environment during the striking cycle, and a striking unit that includes a striking pin movable in a nail-striking direction by air pressure in the cylinder unit from a pre-striking position to a post-striking position to strike a nail, the striking pin including a driven protrusion, said lifting gear assembly comprising:
a muzzle seat adapted to be connected to the cylinder unit, and having an accommodating space and a nail-striking passage that is in spatial communication with said accommodating space and that extends in the nail-striking direction;
a sprocket unit including two sprocket wheels that are spaced apart from each other in the nail-striking direction and that are rotatably mounted in said accommodating space;
a motor unit mounted to said muzzle seat and operable for driving rotation of one of said sprocket wheels; and
a chain unit including
a roller chain that is trained on said sprocket wheels, and
at least one lifting gear device that is mounted to said roller chain, and that includes a pushing member driven movably by said roller chain along a path, said path having a first stroke in which said pushing member moves in a pressure-generating direction opposite to the nail-striking direction, said pushing member being adapted to push the driven protrusion of the striking pin, when moving along the first stroke, to move the striking pin from the post-striking position to the pre-striking position to thereby increase air pressure in the cylinder unit.

2. The lifting gear assembly as claimed in claim 1, wherein:
said path of said pushing member further has a second stroke in which said pushing member moves in the nail-striking direction; and
said pushing member is away from said driven protrusion when moving along the second stroke.

3. The lifting gear assembly as claimed in claim 1, wherein:
said at least one lifting gear device further includes two positioning plates disposed respectively at opposite sides of said roller chain that are spaced apart in a direction transverse to the path; and
each of said positioning plates has a first vertex portion, a second vertex portion and a third vertex portion, said first vertex portion and said second vertex portion being connected fixedly to said roller chain, said third vertex portion protruding outwardly from said roller chain, said pushing member being connected rotatably between said third vertex portions of said positioning plates.

4. The lifting gear assembly as claimed in claim 1, wherein said at least one lifting gear device includes two lifting gear devices spaced apart from each other.

5. An electric nail gun comprising:
a main body unit including a trigger device that is operable to start a striking cycle;
a cylinder unit mounted to said main body unit and having
an air storage chamber that stores air therein and that is isolated from an external environment during the striking cycle, and
a cylinder chamber that is in spatial communication with said air storage chamber;
a striking unit inserted in said cylinder chamber and including a striking pin that is movable in a nail-striking direction by air pressure in said cylinder unit from a pre-striking position to a post-striking position to strike a nail, said striking pin including a driven protrusion; and
a lifting gear assembly as claimed in claim 1.

6. The electric nail gun as claimed in claim 5, wherein said cylinder unit includes an air storage cylinder and a striking cylinder that is disposed in said air storage cylinder and that defines said cylinder chamber therein, said air storage cylinder cooperating with said striking cylinder to define said air storage chamber therebetween.

7. The electric nail gun as claimed in claim 5, wherein said driven protrusion has an abutment surface substantially perpendicular to the nail-striking direction, said pushing member abutting against said abutment surface, when moving along the first stroke, to move said striking pin from the post-striking position to the pre-striking position to thereby increase air pressure in said cylinder unit.

8. The electric nail gun as claimed in claim 7, wherein:
said striking pin further has a longitudinal side surface extending in the nail-striking direction;
said driven protrusion protrudes from said longitudinal side surface;
said abutment surface is perpendicular to said longitudinal side surface;
said driven protrusion further has an inclined surface interconnecting a distal end of said abutment surface and said longitudinal side surface, a distance between said inclined surface and said longitudinal side surface decreasing in the pressure-generating direction.

9. The electric nail gun as claimed in claim 5, wherein:
said striking pin further includes a plurality of limiting protrusions that are spaced apart from each other in the nail-striking direction and that are opposite to said driven protrusion in a direction transverse to the nail-striking direction; and
said electric nail gun further comprises an blocking unit that includes
an blocking member being adjacent to one of said limiting protrusions when said striking pin is at the pre-striking position to obstruct movement of said striking pin toward the post-striking position, and
a driving set operable to move said blocking member away from said one of said limiting protrusions to allow movement of said striking pin toward the post-striking position.

10. The electric nail gun as claimed in claim 9, wherein:
said blocking unit further includes a positioning seat connected to said muzzle seat and formed with a through hole;
said blocking member includes
a rotating portion rotatably extends through said through hole, and
a pawl portion that is connected to said rotating portion, such that rotation of said rotating portion drives said pawl portion to be adjacent to and away from said one of said limiting protrusions;
said blocking unit further includes a rotary arm having a first end and a second end that is opposite to said first end and that is connected co-rotatably to said rotating portion;
said driving set is configured to be a solenoid valve, and includes a valve rod connected fixedly to said first end of said rotary arm and movable between an extended position and a retracted position to drive rotation of said rotary arm, thereby resulting in rotation of said rotating portion;
when said striking pin is at the pre-striking position and said valve rod is at the extended position, said pawl portion is moved, via said rotary arm, to be adjacent to said one of said limiting protrusions;
when said striking pin is at the pre-striking position and said driving set is energized to move said valve rod from the extended position to the retracted position, said pawl portion is moved, via said rotary arm, away from said one of said limiting protrusions;
said blocking unit further includes a biasing member sleeved on said valve rod for biasing said valve rod toward the extended position; and
when said striking pin is at the post-striking position and said valve rod is biased by said biasing member to the extended position, said limiting protrusions sequentially pushes said pawl portion of said blocking member to drive rotation of said rotating portion of said blocking member, thereby resiliently moving said valve rod, via said rotary arm to the retracted position against a biasing force of said biasing member during movement of said striking pin in the pressure-generating direction.

11. The electric nail gun as claimed in claim 5, wherein:
said path of said pushing member further has a second stroke in which said pushing member moves in the nail-striking direction; and
said pushing member is away from said driven protrusion when moving along the second stroke.

12. The electric nail gun as claimed in claim 5, wherein:
said at least one lifting gear device further includes two positioning plates disposed respectively at opposite sides of said roller chain that are spaced apart in a direction transverse to the path; and
each of said positioning plates has a first vertex portion, a second vertex portion and a third vertex portion, said first vertex portion and said second vertex portion being connected fixedly to said roller chain, said third vertex portion protruding outwardly from said roller chain, said pushing member being connected rotatably between said third vertex portions of said positioning plates.

13. The electric nail gun as claimed in claim 5, wherein said at least one lifting gear device includes two lifting gear devices spaced apart from each other.
